(19) United States
(12) Patent Application Publication
(10) Pub. No.: US 2005/0058853 A1
(43) Pub. Date: Mar. 17, 2005

(54) Green organic light-emitting diodes

(75) Inventors: Lelia Cosimbescu, Rochester, NY (US); Tukaram K. Hatwar, Penfield, NY (US)

Correspondence Address: Paul A. Leipold;Patent Legal Staff, Eastman Kodak Company, 343 State Street, Rochester, NY, 14650-2201, US

(73) Assignee: Eastman Kodak Company

(21) Appl. No.: 10/662,272

(22) Filed: Sep. 15, 2003

(51) Int. Cl. H05B 33/12

(52) U.S. Cl. 428/690; 428/917; 313/504; 313/506

(57) ABSTRACT

Disclosed is an electroluminescent device having a cathode and an anode, an organic light emitting layer (LEL) containing at least one organic host material and a light emitting first dopant, and a layer containing a stabilizing second dopant wherein: a) the organic host material is capable of sustaining both hole and electron injection and recombination of electrons and holes; and b) the first dopant is a green light emitting organic material capable of accepting energy from the electron-hole recombination in the host material and of accepting energy transferred from the second dopant and is selected to have a bandgap energy lower than or equal to the bandgap energy of the second dopant material; c) the second dopant is a stabilizing material capable of accepting energy of electron-hole recombination in the host material, the second dopant being selected to have a bandgap energy lower than the bandgap energy of the host material, but higher or equal to the first dopant; wherein emissions from the first dopant and emissions from the second dopant, if any, have a peak emission in the OLED device less than 570 nm.

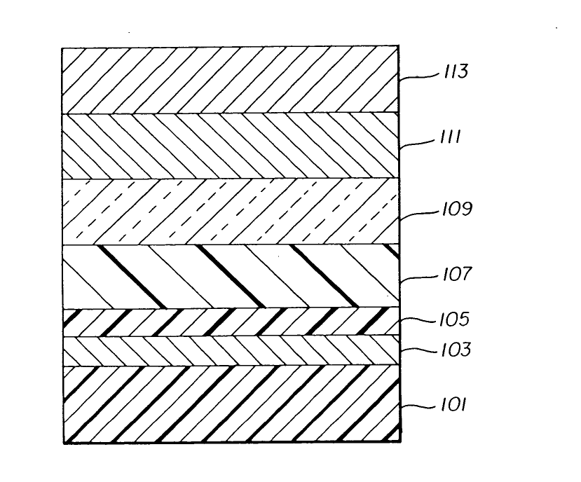

### CROSS-REFERENCE TO RELATED APPLICATIONS

Reference is made to commonly assigned U.S. patent application Ser. No. 10/184,356 filed Jun. 27, 2002 and U.S. patent application Ser. No. 10/252,487 filed Sep. 23, 2002 both entitled “Device Containing Green Organic Light-Emitting Diode”

### FIELD OF THE INVENTION

This invention relates to organic electroluminescent (EL) devices. More specifically, this invention relates to green EL devices having an emission peak less than 570 nm and containing a selected combination of dopants including a stabilizing dopant.

### BACKGROUND OF THE INVENTION

While organic electroluminescent (EL) devices have been known for over two decades, their performance limitations have represented a barrier to many desirable applications. In simplest form, an organic EL device is comprised of an anode for hole injection, a cathode for electron injection, and an organic medium sandwiched between these electrodes to support charge recombination that yields emission of light. These devices are also commonly referred to as organic light-emitting diodes, or OLEDs. Representative of earlier organic EL devices are Gurnee et al. U.S. Pat. No. 3,172,862, issued Mar. 9, 1965; Gurnee U.S. Pat. No. 3,173,050, issued Mar. 9, 1965; Dresner, “Double Injection Electroluminescence in Anthracene”, RCA Review, Vol. 30, pp. 322-334, 1969; and Dresner U.S. Pat. No. 3,710,167, issued Jan. 9, 1973. The organic layers in these devices, usually composed of a polycyclic aromatic hydrocarbon, were very thick (much greater than 1 μm). Consequently, operating voltages were very high, often >100V.

More recent organic EL devices include an organic EL element consisting of extremely thin layers (e.g. <1.0 μm) between the anode and the cathode. Herein, the term “organic EL element” encompasses the layers between the anode and cathode electrodes. Reducing the thickness lowered the resistance of the organic layer and has enabled devices that operate much lower voltage. In a basic two-layer EL device structure, described first in U.S. Pat. No. 4,356,429, one organic layer of the EL element adjacent to the anode is specifically chosen to transport holes, therefore, it is referred to as the hole-transporting layer, and the other organic layer is specifically chosen to transport electrons, referred to as the electron-transporting layer. Recombination of the injected holes and electrons within the organic EL element results in efficient electroluminescence.

There have also been proposed three-layer organic EL devices that contain an organic light-emitting layer (LEL) between the hole-transporting layer and electron-transporting layer, such as that disclosed by Tang et al [J. Applied Physics, Vol. 65, Pages 3610-3616, 1989]. The light-emitting layer commonly consists of a host material doped with a guest material. Still further, there has been proposed in U.S. Pat. No. 4,769,292 a four-layer EL element comprising a hole-injecting layer (HIL), a hole-transporting layer (HTL), a light-emitting layer (LEL) and an electron transport/injection layer (ETL). These structures have resulted in improved device efficiency.

Quinacridones for example have been studied as emissive dopants for OLED devices, e.g., as described in U.S. Pat. No. 5,227,252, JP 09-13026, U.S. Pat. No. 5,593,788, JP 11-54283, and JP 11-67449. U.S. Pat. No. 5,593,788 teaches that substitution on the nitrogen of the quinacridone improves stability. However, the stability of quinacridone derivatives as taught in the prior art, as well as other green emitters, is not sufficient for various applications. Thus, there is still a need for green-emitting devices with higher stability.

### SUMMARY OF THE INVENTION

The invention provides an electroluminescent device having a cathode and an anode, an organic light emitting layer (LEL) containing at least one organic host material and a light emitting first dopant, and a layer containing a stabilizing second dopant wherein:
a) the organic host material is capable of sustaining both hole and electron injection and recombination of electrons and holes; and
b) the first dopant is a green light emitting organic material capable of accepting energy from the electron-hole recombination in the host material and of accepting energy transferred from the second dopant and is selected to have a bandgap energy lower than or equal to the bandgap energy of the second dopant material;
c) the second dopant is a stabilizing material capable of accepting energy of electron-hole recombination in the host material, the second dopant being selected to have a bandgap energy lower than the bandgap energy of the host material, but higher or equal to the first dopant;
wherein emissions from the first dopant and emissions from the second dopant, if any, have a peak emission in the OLED device less than 570 nm.

The invention also provides a display employing the device.

The device exhibits improved stability.

### BRIEF DESCRIPTION OF THE DRAWINGS

The FIGURE shows a cross-section of an OLED device of this invention.

### DETAILED DESCRIPTION OF THE INVENTION

The invention is generally summarized above. Particular examples of green emitting first dopants are as defined in Formula 1, 2 or 3 and of stabilizing second dopants are as defined in Formula 4.

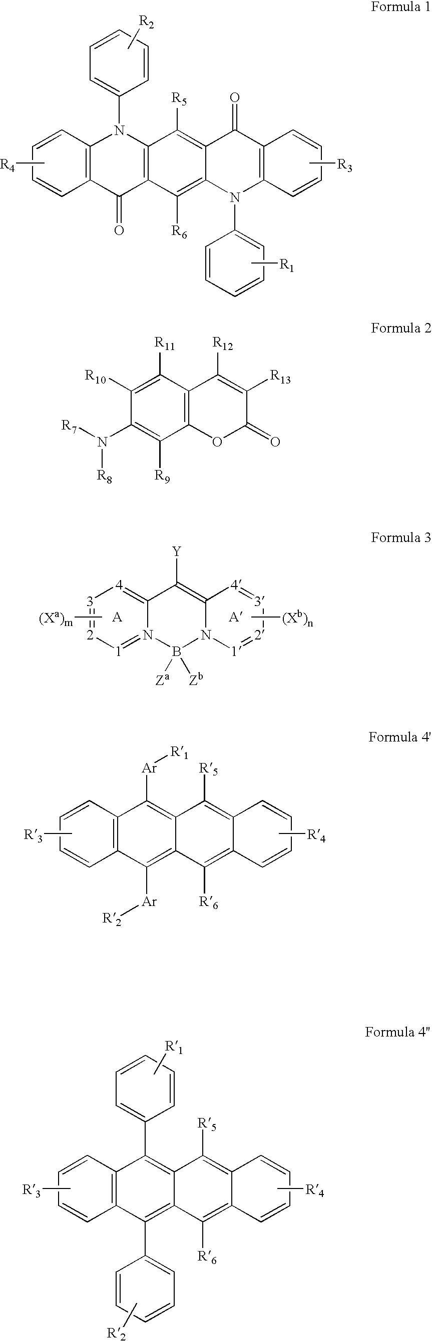

In Formula 1, R₁-R₆ represent hydrogen, one or more substituents such as halogen, alkyl, cyano group, nitro group, hydroxy, alkoxy group, aryloxy group, aryl group, an alkylthio group, arylthio group or an aromatic heterocycle. R₁ or R₂ may form a fused aromatic or heteroaromatic ring to the phenyl moiety. R₃ and R₄ do not form fused aromatic rings to the central quinacridone structure. Suitably, R₁-R₆ is: hydrogen, halogen, alkyl, aryl, or an aromatic heterocycle. Usefully, R₁-R₄ is hydrogen, halogen, methyl, phenyl, biphenyl, or naphthyl, and R₅ and R₆ are hydrogen (e.g. see Inv-1a and Inv-6a).

In Formula 2, R₉-R₁₃ independently represents hydrogen, halogen, alkyl, alkoxy, alkylthio group, arylthio group, aryl, an electron withdrawing group such as a cyano group, nitro group or trifluoromethyl group, an aromatic heterocycle, or an heterocyclic ring fused to the aromatic moiety. R₇ and R₈ independently represent an alkyl group, aryl group, an aromatic heterocycle or a heterocyclic group fused together, and/or fused to the aromatic moiety. Conveniently, R₉-R₁₂ is a hydrogen atom, a halogen, an alkyl group, an alkoxy group, a trifluoromethyl group, a phenyl group and R₁₃ is conveniently a hydrogen atom, a phenyl group, a pyridine group, a benzoxazole or a benzothiazole group. All of the ring substituents may be themselves further substituted, using substituents selected by those skilled in the art to attain a desired property. Conveniently, R₇-R₈ can be an alkyl group or a heterocyclic group and both substituents are identical. Usefully, R₉-R₁₂ is a hydrogen, R₁₃ is either a benzothiazole or a benzoxazole, either substituted or unsubstituted; R₇-R₈ are both methyl, ethyl or substituted or unsubstituted piperidine groups fused to each other and to the phenyl moiety.

In Formula 3, each X^{a} and X^{b} is an independently selected substituent, two of which may join to form a fused ring to the azine ring moiety; m and n are independently 0 to 4; Y is H or a substituent; Z^{a} and Z^{b} are independently selected substituents; 1, 2, 3, 4, 1′, 2′, 3′, and 4′ are independently selected as either carbon or nitrogen atoms. The device may desirably contain at least one or both of rings A and A′, that contains substituents joined to form a fused ring. In one useful embodiment, there is present at least one X^{a} or X^{b} group selected from the group consisting of halide and alkyl, aryl, alkoxy, and aryloxy groups. In another embodiment, there is present a Z^{a} and Z^{b} group are independently selected from the group consisting of fluorine and alkyl, aryl, alkoxy and aryloxy groups. A desirable embodiment is where Z^{a} and Z^{b} are F. Y is suitably hydrogen or a substituent such as an alkyl, aryl, halogen, cyano group or a heterocyclic group.

In Formula 4′, each Ar is an independently selected carbocyclic or heterocyclic (N, O, or S containing) aromatic ring substituent and R′₁-R′₆ independently represent hydrogen or one or more substituents such as, halogen, cyano group, nitro group, an alkyl group, hydroxy, alkoxy group, aryloxy group, an alkylthio group, an amino group, an arylthio group, either an aryl group or an aromatic heterocycle, either of which can be fused to the phenyl moiety. R₁₃ and R₁₄ do not form fused rings to the central naphthacene structure. More preferably, R′₁-R′₆ is hydrogen, halogen, alkyl, aryl group fused or non-fused to the phenyl moiety. Most preferably, R′₁-R′₄ is hydrogen, halogen, alkyl such as t-butyl, aryl such as pyrene, and R₁₅ and R₁₆ are hydrogen (e.g. see Inv-1b and Inv-3b). Each Ar ring is preferably a phenyl ring as shown in Formula 4″.

For formulae 1-3, if desired, the substituents may themselves be further substituted. The particular substituents used may be selected by those skilled in the art to attain the desired properties for a specific application and can include, for example, electron-withdrawing groups and steric groups. When a molecule may have two or more substituents, the substituents may be joined together to form a ring such as a fused ring unless otherwise provided.

The first and second dopants have a maximum green emission peak in an OLED device in the wavelength region of less than 570 nm, typically between 470-570, conveniently between 490-540.

Useful compounds of this invention include a combination of a first dopant from group Inv-a and a second dopant from group Inv-b.

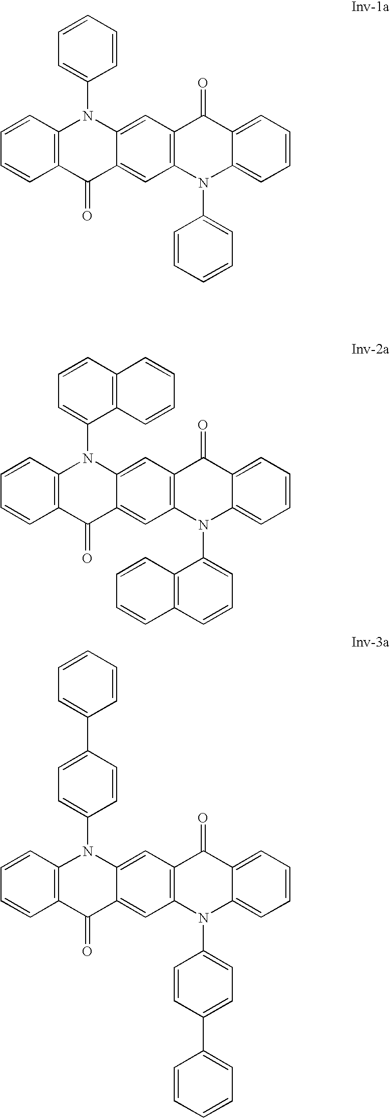

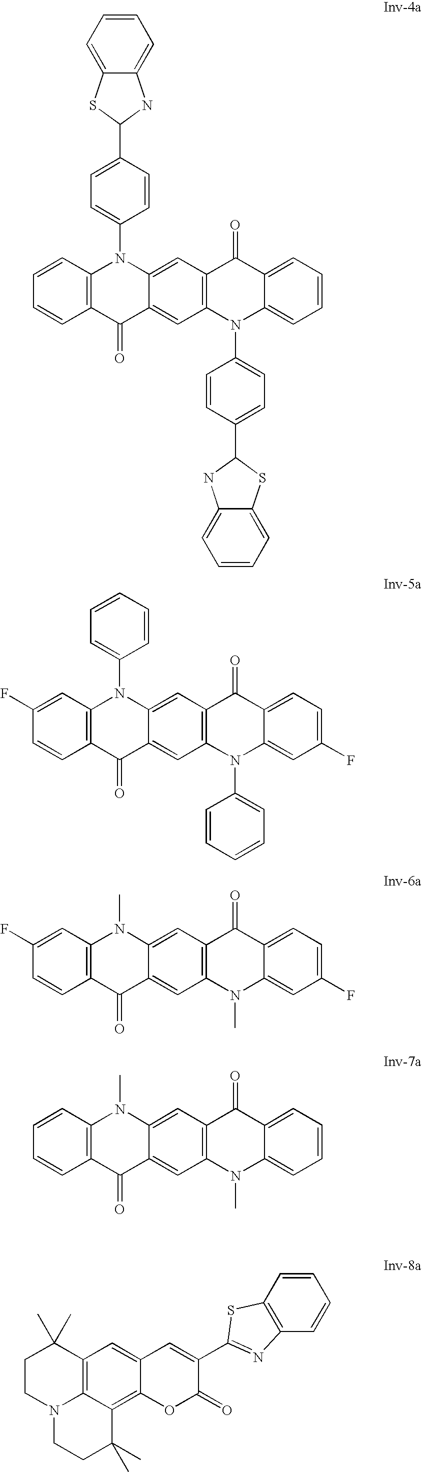

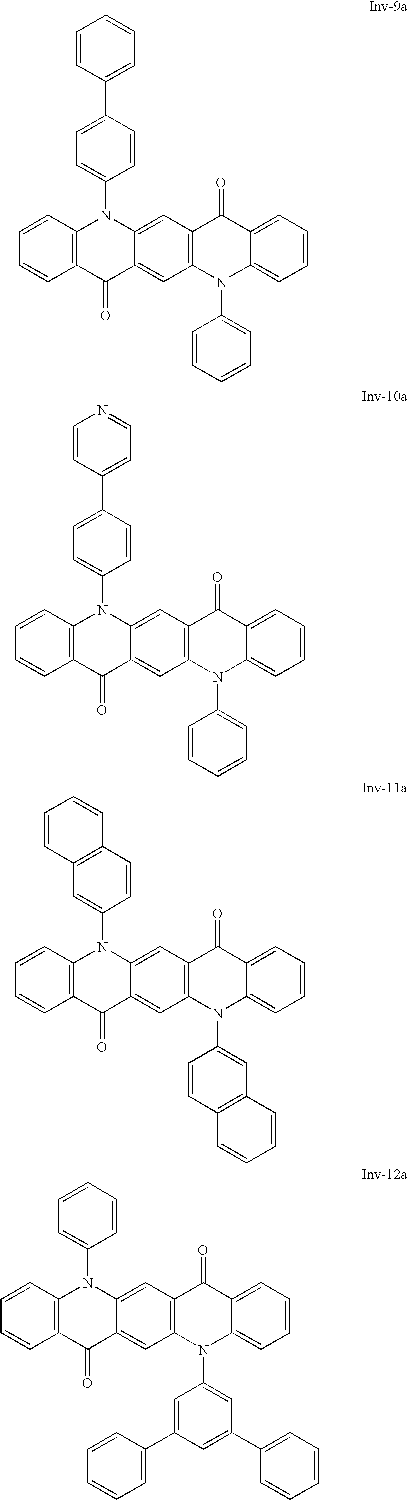

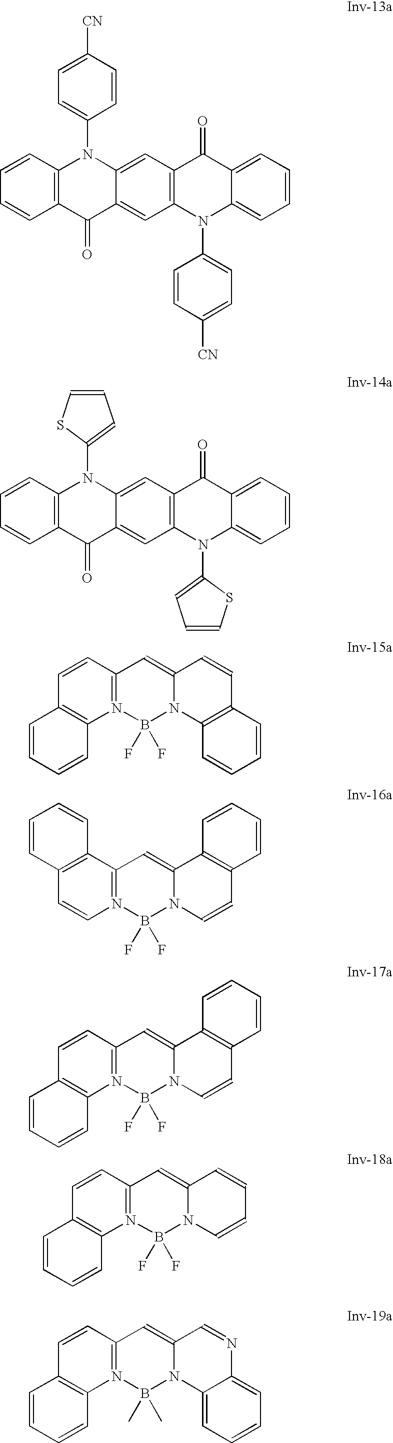

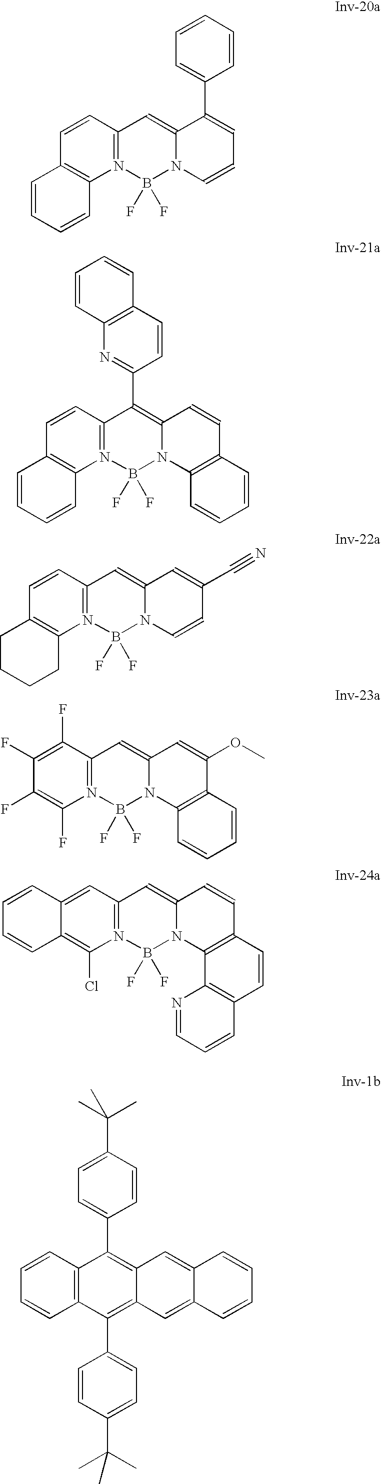

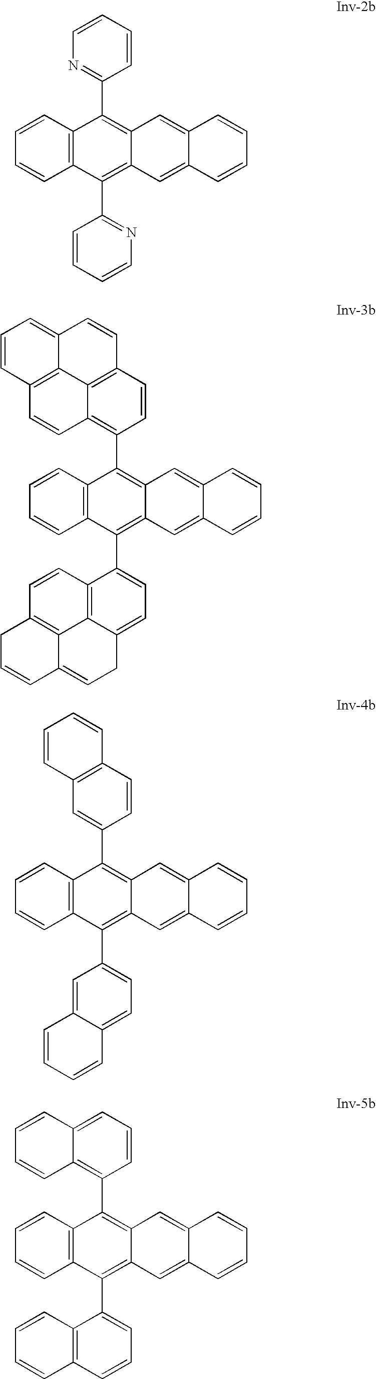

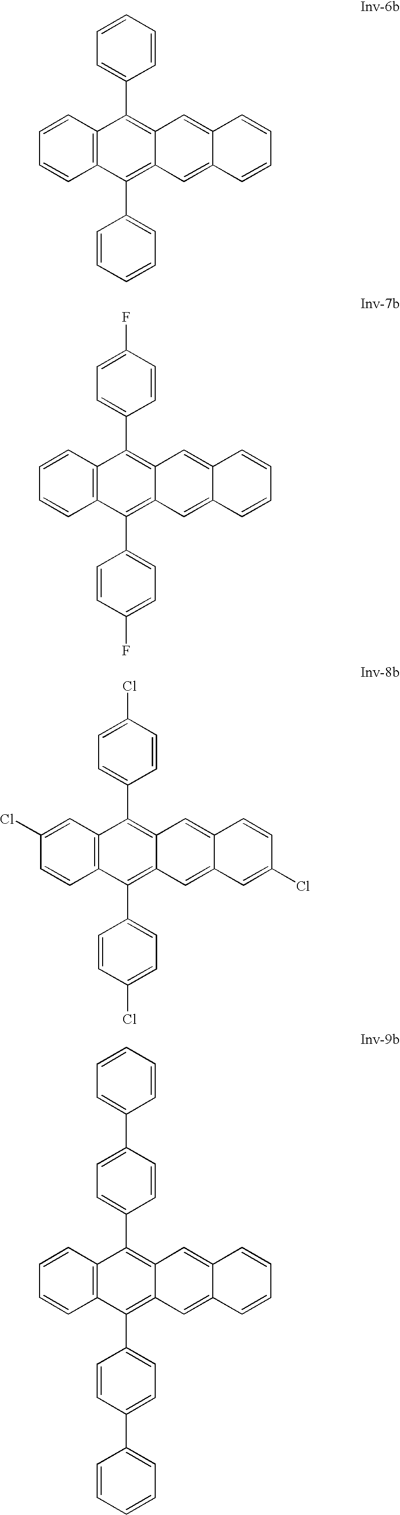

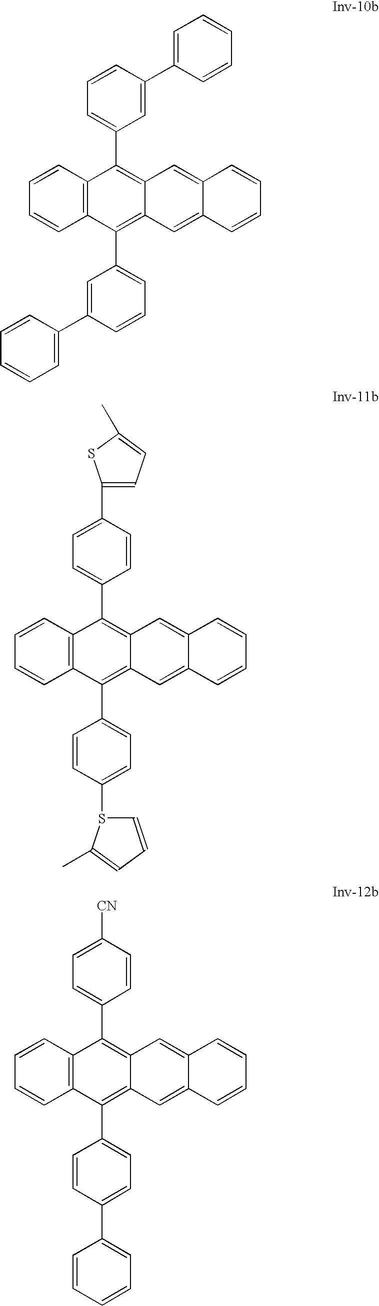

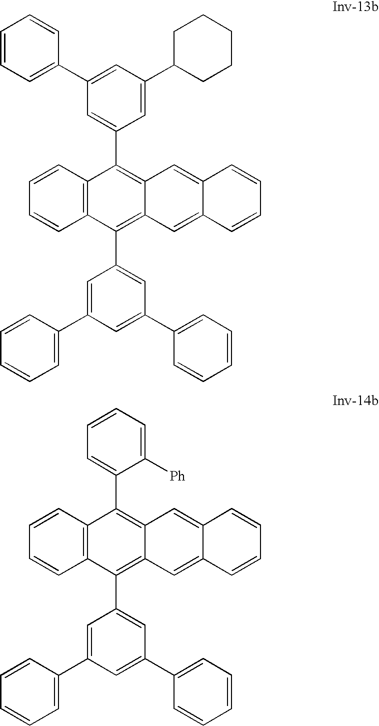

Compounds of Formula Inv-a and Inv-b are typically employed in a light-emitting layer comprising some amount of the inventive compounds combination molecularly dispersed in a host as defined below. Examples of useful host materials (defined below) include metal complexes, such as aluminum, magnesium, gallium of 8-hydroxy quinoline and similar derivatives, substituted derivatives of 9,10-diaryl anthracenes, distyrylarylene derivatives and mixtures thereof, and benzazole derivatives. Suitably, the host comprises Alq3, ADN, TBADN or a mixture therof. Green emitter derivatives of this invention are typically used from 0.1 to 10% weight ratio to host, typically less than 3%, usefully between 0.5-1%. The stabilizer dopant levels are typically used between 0.1-10%, suitably less than 5%, with the most useful embodiment between 0.5-1%.

Embodiments of the invention contemplate including one or more stabilizing second dopants in layers other than LEL layers such as hole-transporting or electron-transporting layers. Embodiments of the green emitting devices of the invention have significantly improved operational and storage stability, exhibit good color and high luminance efficiency, and can be used in a wide variety of applications that require high efficiency and high stability.

General Device Architecture

The present invention can be employed in most OLED device configurations. These include very simple structures comprising a single anode and cathode to more complex devices, such as passive matrix displays comprised of orthogonal arrays of anodes and cathodes to form pixels, and active-matrix displays where each pixel is controlled independently, for example, with thin film transistors (TFTs).

There are numerous configurations of the organic layers wherein the present invention can be successfully practiced. A typical structure is shown in the FIGURE and is comprised of a substrate 101, an anode 103, a hole-injecting layer 105, a hole-transporting layer 107, a light-emitting layer 109, an electron-transporting layer 111, and a cathode 113. These layers are described in detail below. Note that the substrate may alternatively be located adjacent to the cathode, or the substrate may actually constitute the anode or cathode. The organic layers between the anode and cathode are conveniently referred to as the organic EL element. Also, the total combined thickness of the organic layers is preferably less than 500 nm.

The OLED device is operated by applying a potential between the anode and cathode such that the anode is at a more positive potential than the cathode. Holes are injected into the organic EL element from the anode and electrons are injected into the organic EL element at the anode. Enhanced device stability can sometimes be achieved when the OLED is operated in an AC mode where, for some time period in the cycle, the potential bias is reversed and no current flows. An example of an AC driven OLED is described in U.S. Pat. No. 5,552,678.

Substrate

The OLED device of this invention is typically provided over a supporting substrate 101 where either the cathode or anode can be in contact with the substrate. The electrode in contact with the substrate is conveniently referred to as the bottom electrode. Conventionally, the bottom electrode is the anode, but this invention is not limited to that configuration. The substrate can either be light transmissive or opaque, depending on the intended direction of light emission. The light transmissive property is desirable for viewing the EL emission through the substrate. Transparent glass or plastic is commonly employed in such cases. The substrate may be a complex structure comprising multiple layers of materials. This is typically the case for active matrix substrates wherein TFTs are provided below the OLED layers. It is still necessary that the substrate, at least in the emissive pixilated areas, be comprised of largely transparent materials such as glass or polymers. For applications where the EL emission is viewed through the top electrode, the transmissive characteristic of the bottom support is immaterial, and therefore can be light transmissive, light absorbing or light reflective. Substrates for use in this case include, but are not limited to, glass, plastic, semiconductor materials, silicon, ceramics, and circuit board materials. Again, the substrate may be a complex structure comprising multiple layers of materials such as found in active matrix TFT designs. Of course it is necessary to provide in these device configurations a light-transparent top electrode.

Anode

When EL emission is viewed through anode 103, the anode should be transparent or substantially transparent to the emission of interest. Common transparent anode materials used in this invention are indium-tin oxide (ITO), indium-zinc oxide (IZO) and tin oxide, but other metal oxides can work including, but not limited to, aluminum- or indium-doped zinc oxide, magnesium-indium oxide, and nickel-tungsten oxide. In addition to these oxides, metal nitrides, such as gallium nitride, and metal selenides, such as zinc selenide, and metal sulfides, such as zinc sulfide, can be used as the anode 103. For applications where EL emission is viewed only through the cathode electrode, the transmissive characteristics of anode are immaterial and any conductive material can be used, transparent, opaque or reflective. Example conductors for this application include, but are not limited to, gold, iridium, molybdenum, palladium, and platinum. Typical anode materials, transmissive or otherwise, have a work function of 4.1 eV or greater. Desired anode materials are commonly deposited by any suitable means such as evaporation, sputtering, chemical vapor deposition, or electrochemical means. Anodes can be patterned using well-known photolithographic processes. Optionally, anodes may be polished prior to application of other layers to reduce surface roughness so as to minimize shorts or enhance reflectivity.

Hole-Injecting Layer (HIL)

While not always necessary, it is often useful that a hole-injecting layer 105 be provided between anode 103 and hole-transporting layer 107. The hole-injecting material can serve to improve the film formation property of subsequent organic layers and to facilitate injection of holes into the hole-transporting layer. Suitable materials for use in the hole-injecting layer include, but are not limited to, porphyrinic compounds as described in U.S. Pat. No. 4,720,432, plasma-deposited fluorocarbon polymers as described in U.S. Pat. No. 6,208,075, and some aromatic amines, for example, m-MTDATA (4,4′,4″-tris[(3-methylphenyl)phenylamino]triphenylamine). Alternative hole-injecting materials reportedly useful in organic EL devices are described in EP 0 891 121 A1 and EP 1 029 909 A1.

Hole-Transporting Layer (HTL)

The hole-transporting layer 107 of the organic EL device contains at least one hole-transporting compound such as an aromatic tertiary amine, where the latter is understood to be a compound containing at least one trivalent nitrogen atom that is bonded only to carbon atoms, at least one of which is a member of an aromatic ring. In one form the aromatic tertiary amine can be an arylamine, such as a monoarylamine, diarylamine, triarylamine, or a polymeric arylamine. Exemplary monomeric triarylamines are illustrated by Klupfel et al. U.S. Pat. No. 3,180,730. Other suitable triarylamines substituted with one or more vinyl radicals and/or comprising at least one active hydrogen containing group are disclosed by Brantley et al U.S. Pat. No. 3,567,450 and U.S. Pat. No. 3,658,520.

A more preferred class of aromatic tertiary amines are those which include at least two aromatic tertiary amine moieties as described in U.S. Pat. No. 4,720,432 and U.S. Pat. No. 5,061,569. Such compounds include those represented by structural formula (A). 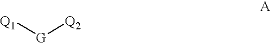
wherein Q₁ and Q₂ are independently selected aromatic tertiary amine moieties and G is a linking group such as an arylene, cycloalkylene, or alkylene group of a carbon to carbon bond. In one embodiment, at least one of Q1 or Q2 contains a polycyclic fused ring structure, e.g., a naphthalene. When G is an aryl group, it is conveniently a phenylene, biphenylene, or naphthalene moiety.

A useful class of triarylamines satisfying structural formula (A) and containing two triarylamine moieties is represented by structural formula (B): 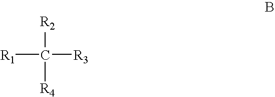
where
R₁ and R₂ each independently represents a hydrogen atom, an aryl group, or an alkyl group or R₁ and R₂ together represent the atoms completing a cycloalkyl group; and
R₃ and R₄ each independently represents an aryl group, which is in turn substituted with a diaryl substituted amino group, as indicated by structural formula (C): 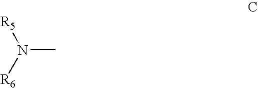
   wherein R₅ and R₆ are independently selected aryl groups. In one embodiment, at least one of R₅ or R₆ contains a polycyclic fused ring structure, e.g., a naphthalene.

Another class of aromatic tertiary amines are the tetraaryldiamines. Desirable tetraaryldiamines include two diarylamino groups, such as indicated by formula (C), linked through an arylene group. Useful tetraaryldiamines include those represented by formula (D). 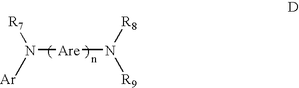
wherein
each Are is an independently selected arylene group, such as a phenylene or anthracene moiety,
n is an integer of from 1 to 4, and
Ar, R₇, R₈, and R₉ are independently selected aryl groups.
   In a typical embodiment, at least one of Ar, R₇, R₈, and R₉ is a polycyclic fused ring structure, e.g., a naphthalene

The various alkyl, alkylene, aryl, and arylene moieties of the foregoing structural formulae (A), (B), (C), (D), can each in turn be substituted. Typical substituents include alkyl groups, alkoxy groups, aryl groups, aryloxy groups, and halogen such as fluoride, chloride, and bromide. The various alkyl and alkylene moieties typically contain from about 1 to 6 carbon atoms. The cycloalkyl moieties can contain from 3 to about 10 carbon atoms, but typically contain five, six, or seven ring carbon atoms—e.g., cyclopentyl, cyclohexyl, and cycloheptyl ring structures. The aryl and arylene moieties are usually phenyl and phenylene moieties.

The hole-transporting layer can be formed of a single or a mixture of aromatic tertiary amine compounds. Specifically, one may employ a triarylamine, such as a triarylamine satisfying the formula (B), in combination with a tetraaryldiamine, such as indicated by formula (D). When a triarylamine is employed in combination with a tetraaryldiamine, the latter is positioned as a layer interposed between the triarylamine and the electron injecting and transporting layer. Illustrative of useful aromatic tertiary amines are the following:
1,1-Bis(4-di-p-tolylaminophenyl)cyclohexane
1,1-Bis(4-di-p-tolylaminophenyl)-4-phenylcyclohexane
4,4′-Bis(diphenylamino)quadriphenyl
   Bis(4-dimethylamino-2-methylphenyl)-phenylmethane
   N,N,N-Tri(p-tolyl)amine
   4-(di-p-tolylamino)-4′-[4(di-p-tolylamino)-styryl]stilbene
   N,N,N′,N′-Tetra-p-tolyl-4-4′-diaminobiphenyl
N,N,N′,N′-Tetraphenyl-4,4′-diaminobiphenyl
N,N,N′,N′-tetra-1-naphthyl-4,4′-diaminobiphenyl
N,N,N′,N′-tetra-2-naphthyl-4,4′-diaminobiphenyl
N-Phenylcarbazole
4,4′-Bis[N-(1-naphthyl)-N-phenylamino]biphenyl
4,4′-Bis[N-(1-naphthyl)-N-(2-naphthyl)amino]biphenyl
4,4″-Bis[N-(1-naphthyl)-N-phenylamino]ₚ-terphenyl
4,4′-Bis[N-(2-naphthyl)-N-phenylamino]biphenyl
4,4′-Bis[N-(3-acenaphthenyl)-N-phenylamino]biphenyl
1,5-Bis[N-(1-naphthyl)-N-phenylamino]naphthalene
4,4′-Bis[N-(9-anthryl)-N-phenylamino]biphenyl
4,4″-Bis[N-(1-anthryl)-N-phenylamino]-p-terphenyl
4,4′-Bis[N-(2-phenanthryl)-N-phenylamino]biphenyl
4,4′-Bis[N-(8-fluoranthenyl)-N-phenylamino]biphenyl
4,4′-Bis[N-(2-pyrenyl)-N-phenylamino]biphenyl
4,4′-Bis[N-(2-naphthacenyl)-N-phenylamino]biphenyl
4,4′-Bis[N-(2-perylenyl)-N-phenylamino]biphenyl
4,4′-Bis[N-(1-coronenyl)-N-phenylamino]biphenyl
2,6-Bis(di-p-tolylamino)naphthalene
2,6-Bis[di-(1-naphthyl)amino]naphthalene
2,6-Bis[N-(1-naphthyl)-N-(2-naphthyl)amino]naphthalene
N,N,N′,N′-Tetra(2-naphthyl)-4,4″-diamino-p-terphenyl
4,4′-Bis {N-phenyl-N-[4-(1-naphthyl)-phenyl]amino}biphenyl
4,4′-Bis[N-phenyl-N-(2-pyrenyl)amino]biphenyl
2,6-Bis[N,N-di(2-naphthyl)amine]fluorene
1,5-Bis[N-(1-naphthyl)-N-phenylamino]naphthalene
4,4′,4″-tris[(3-methylphenyl)phenylamino]triphenylamine

Another class of useful hole-transporting materials includes polycyclic aromatic compounds as described in EP 1 009 041. Tertiary aromatic amines with more than two amine groups may be used including oligomeric materials. In addition, polymeric hole-transporting materials can be used such as poly(N-vinylcarbazole) (PVK), polythiophenes, polypyrrole, polyaniline, and copolymers such as poly(3,4-ethylenedioxythiophene)/poly(4-styrenesulfonate) also called PEDOT/PSS.

Light-Emitting Layer (LEL)

This invention is primarily directed to the light-emitting layer (LEL). As described above, the compound of Formula 1, Formula 2 or Formula 3 together with a second green dopant of Formula 2 is commonly used along with a host to yield green emission. The green OLED of this invention may be used along with other dopants or LELs to alter the emissive color, e.g., to make white. In addition, the green OLED of this invention can be used along with other OLED devices to make full color display devices. Various aspects of the host of this invention and other OLED devices and dopants with which the inventive OLED can be used are described below.

As more fully described in U.S. Pat. Nos. 4,769,292 and 5,935,721, the light-emitting layer (LEL) 109 of the organic EL element includes a luminescent or fluorescent material where electroluminescence is produced as a result of electron-hole pair recombination in this region. The light-emitting layer can be comprised of a single material, but more commonly consists of a host material doped with a guest compound or compounds where light emission comes primarily from the dopant and can be of any color. The host materials in the light-emitting layer can be an electron-transporting material, as defined below, a hole-transporting material, as defined above, or another material or combination of materials that support hole-electron recombination. The dopant is usually chosen from highly fluorescent dyes, but phosphorescent compounds, e.g., transition metal complexes as described in WO 98/55561, WO 00/18851, WO 00/57676, and WO 00/70655 are also useful. Dopants are typically coated as 0.01 to 10% by weight into the host material. Polymeric materials such as polyfluorenes and polyvinylarylenes (e.g., poly(p-phenylenevinylene), PPV) can also be used as the host material. In this case, small molecule dopants can be molecularly dispersed into the polymeric host, or the dopant could be added by copolymerizing a minor constituent into the host polymer.

An important relationship for choosing a dye as a dopant is a comparison of the bandgap potential which is defined as the energy difference between the highest occupied molecular orbital and the lowest unoccupied molecular orbital of the molecule. For efficient energy transfer from the host to the dopant molecule, a necessary condition is that the band gap of the dopant is smaller than that of the host material. For phosphorescent emitters it is also important that the host triplet energy level of the host be high enough to enable energy transfer from host to dopant.

Host and emitting molecules known to be of use include, but are not limited to, those disclosed in U.S. Pat. No. 4,768,292, U.S. Pat. No. 5,141,671, U.S. Pat. No. 5,150,006, U.S. Pat. No. 5,151,629, U.S. Pat. No. 5,405,709, U.S. Pat. No. 5,484,922, U.S. Pat. No. 5,593,788, U.S. Pat. No. 5,645,948, U.S. Pat. No. 5,683,823, U.S. Pat. No. 5,755,999, U.S. Pat. No. 5,928,802, U.S. Pat. No. 5,935,720, U.S. Pat. No. 5,935,721, and U.S. Pat. No. 6,020,078.

Metal complexes of 8-hydroxyquinoline and similar derivatives (Formula E) constitute one class of useful host compounds capable of supporting electroluminescence, and are particularly suitable for light emission of wavelengths longer than 500 nm, e.g., green, yellow, orange, and red. 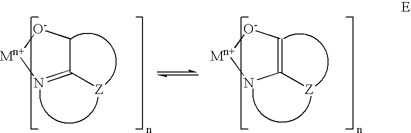
wherein
M represents a metal;
n is an integer of from 1 to 4; and
Z independently in each occurrence represents the atoms completing a nucleus having at least two fused aromatic rings.

From the foregoing it is apparent that the metal can be monovalent, divalent, trivalent, or tetravalent metal. The metal can, for example, be an alkali metal, such as lithium, sodium, or potassium; an alkaline earth metal, such as magnesium or calcium; an earth metal, such aluminum, or a transition metal such as zinc or zirconium. Generally any monovalent, divalent, trivalent, or tetravalent metal known to be a useful chelating metal can be employed.

Z completes a heterocyclic nucleus containing at least two fused aromatic rings, at least one of which is an azole or azine ring. Additional rings, including both aliphatic and aromatic rings, can be fused with the two required rings, if required. To avoid adding molecular bulk without improving on function the number of ring atoms is usually maintained at 18 or less.

Illustrative of useful chelated oxinoid compounds are the following:
CO-1: Aluminum trisoxine [alias, tris(8-quinolinolato)aluminum(III)] (Alq)
CO-2: Magnesium bisoxine [alias, bis(8-quinolinolato)magnesium(II)]
CO-3: Bis[benzo {f}-8-quinolinolato]zinc (II)
CO-4: Bis(2-methyl-8-quinolinolato)aluminum(III)-1-oxo-bis(2-methyl-8-quinolinolato) aluminum(III)
CO-5: Indium trisoxine [alias, tris(8-quinolinolato)indium]
CO-6: Aluminum tris(5-methyloxine) [alias, tris(5-methyl-8-quinolinolato) aluminum(III)]
CO-7: Lithium oxine [alias, (8-quinolinolato)lithium(I)]
CO-8: Zirconium oxine [alias, tetra(8-quinolinolato)zirconium(IV)]
CO-9: Gallium oxine [alias, tris(8-quinolinolato)gallium(III)]

Derivatives of 9,10-di-(2-naphthyl)anthracene (Formula F) constitute one class of useful hosts capable of supporting electroluminescence, and are particularly suitable for light emission of wavelengths longer than 400 nm, e.g., blue, green, yellow, orange or red. 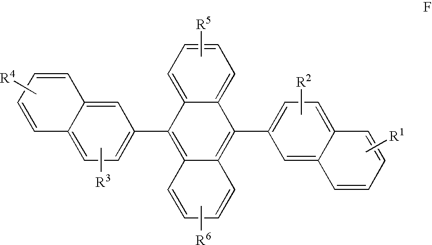
wherein: R¹, R², R³, R⁴, R⁵, and R⁶ represent one or more substituents on each ring where each substituent is individually selected from the following groups:
Group 1: hydrogen, or alkyl of from 1 to 24 carbon atoms;
Group 2: aryl or substituted aryl of from 5 to 20 carbon atoms;
Group 3: carbon atoms from 4 to 24 necessary to complete a fused aromatic ring of anthracenyl; pyrenyl, or perylenyl;
Group 4: heteroaryl or substituted heteroaryl of from 5 to 24 carbon atoms as necessary to complete a fused heteroaromatic ring of furyl, thienyl, pyridyl, quinolinyl or other heterocyclic systems;
Group 5: alkoxylamino, alkylamino, or arylamino of from 1 to 24 carbon atoms; and
Group 6: fluorine, chlorine, bromine or cyano.

Illustrative examples include 9,10-di-(2-naphthyl)anthracene (ADN) and 2-t-butyl-9,10-di-(2-naphthyl)anthracene (TBADN). Other anthracene derivatives can be useful as a host in the LEL, including derivatives of 9,10-bis[4-(2,2-diphenylethenyl)phenyl]anthracene. Mixtures of hosts can also be adventitious, such as mixtures of compounds of Formula E and Formula F.

Benzazole derivatives (Formula G) constitute another class of useful hosts capable of supporting electroluminescence, and are particularly suitable for light emission of wavelengths longer than 400 nm, e.g., blue, green, yellow, orange or red.

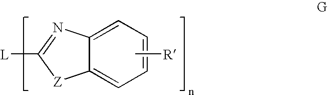

Where:
n is an integer of 3 to 8;
Z is O, NR or S; and
R and R′ are individually hydrogen; alkyl of from 1 to 24 carbon atoms, for example, propyl, t-butyl, heptyl, and the like; aryl or hetero-atom substituted aryl of from 5 to 20 carbon atoms for example phenyl and naphthyl, furyl, thienyl, pyridyl, quinolinyl and other heterocyclic systems; or halo such as chloro, fluoro; or atoms necessary to complete a fused aromatic ring;
   L is a linkage unit consisting of alkyl, aryl, substituted alkyl, or substituted aryl, which conjugately or unconjugately connects the multiple benzazoles together. An example of a useful benzazole is 2,2′,2″-(1,3,5-phenylene)tris[1-phenyl-1H-benzimidazole].

Distyrylarylene derivatives are also useful hosts, as described in U.S. Pat. No. 5,121,029. Carbazole derivatives are particularly useful hosts for phosphorescent emitters.

Useful fluorescent dopants include, but are not limited to, derivatives of anthracene, tetracene, xanthene, perylene, rubrene, coumarin, rhodamine, and quinacridone, dicyanomethylenepyran compounds, thiopyran compounds, polymethine compounds, pyrilium and thiapyrilium compounds, fluorene derivatives, periflanthene derivatives, indenoperylene derivatives, bis(azinyl)amine boron compounds, bis(azinyl)methane compounds, and carbostyryl compounds. Illustrative examples of useful dopants include, but are not limited to, the following:

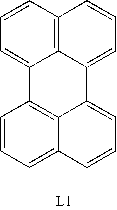

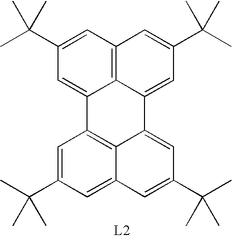

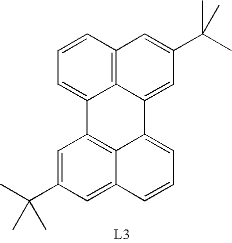

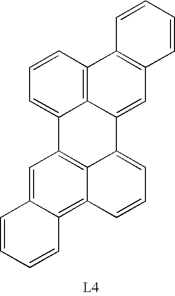

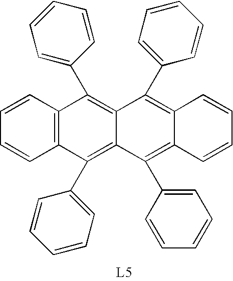

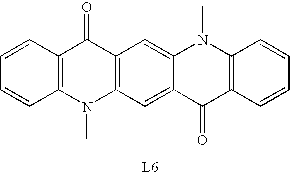

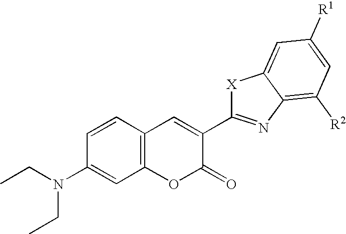

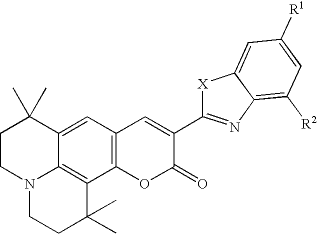

| | X | R1 | R2 |
|---|---|---|---|
| L9 | O | H | H |
| L10 | O | H | Methyl |
| L11 | O | Methyl | H |
| L12 | O | Methyl | Methyl |
| L13 | O | H | t-butyl |
| L14 | O | t-butyl | H |
| L15 | O | t-butyl | t-butyl |
| L16 | S | H | H |
| L17 | S | H | Methyl |
| L18 | S | Methyl | H |
| L19 | S | Methyl | Methyl |
| L20 | S | H | t-butyl |
| L21 | S | t-butyl | H |
| L22 | S | t-butyl | t-butyl |
| L23 | O | H | H |
| L24 | O | H | Methyl |
| L25 | O | Methyl | H |
| L26 | O | Methyl | Methyl |
| L27 | O | H | t-butyl |
| L28 | O | t-butyl | H |
| L29 | O | t-butyl | t-butyl |
| L30 | S | H | H |
| L31 | S | H | Methyl |
| L32 | S | Methyl | H |
| L33 | S | Methyl | Methyl |
| L34 | S | H | t-butyl |
| L35 | S | t-butyl | H |
| L36 | S | t-butyl | t-butyl |

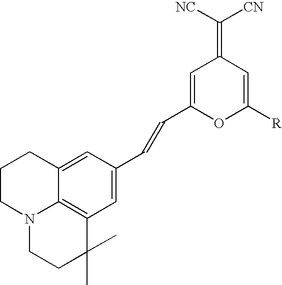

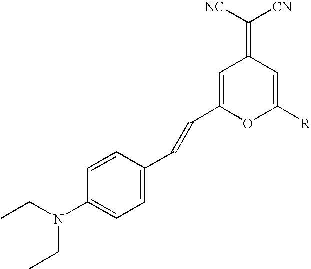

| | R |
|---|---|
| L37 | phenyl |
| L38 | methyl |
| L39 | t-butyl |
| L40 | mesityl |
| L41 | phenyl |
| L42 | methyl |
| L43 | t-butyl |
| L44 | mesityl |

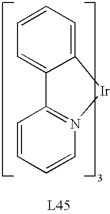

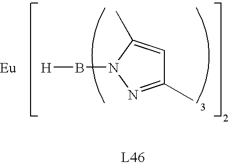

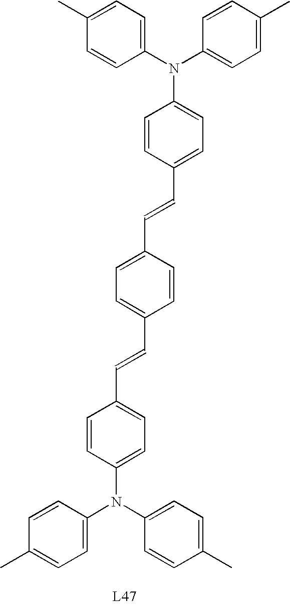

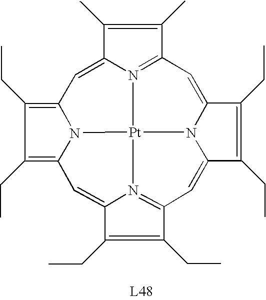

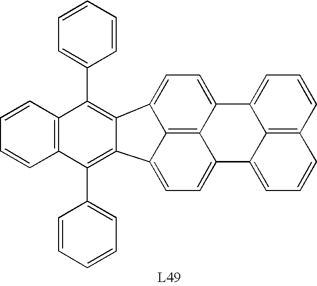

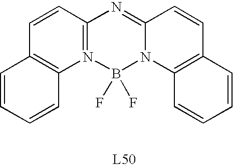

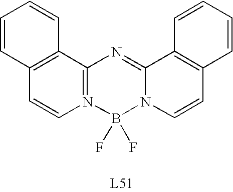

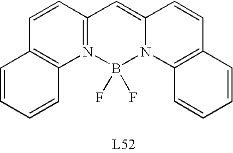

Electron-Transporting Layer (ETL)

Preferred thin film-forming materials for use in forming the electron-transporting layer 111 of the organic EL devices of this invention are metal chelated oxinoid compounds, including chelates of oxine itself (also commonly referred to as 8-quinolinol or 8-hydroxyquinoline). Such compounds help to inject and transport electrons and exhibit both high levels of performance and are readily fabricated in the form of thin films. Exemplary of contemplated oxinoid compounds are those satisfying structural formula (E), previously described.

Other electron-transporting materials include various butadiene derivatives as disclosed in U.S. Pat. No. 4,356,429 and various heterocyclic optical brighteners as described in U.S. Pat. No. 4,539,507. Benzazoles satisfying structural formula (G) are also useful electron transporting materials. Triazines are also known to be useful as electron transporting materials.

Cathode

When light emission is viewed solely through the anode, the cathode 113 used in this invention can be comprised of nearly any conductive material. Desirable materials have good film-forming properties to ensure good contact with the underlying organic layer, promote electron injection at low voltage, and have good stability. Useful cathode materials often contain a low work function metal (<4.0 eV) or metal alloy. One preferred cathode material is comprised of a Mg:Ag alloy wherein the percentage of silver is in the range of 1 to 20%, as described in U.S. Pat. No. 4,885,221. Another suitable class of cathode materials includes bilayers comprising a thin electron-injection layer (EIL) in contact with the organic layer (e.g., ETL) which is capped with a thicker layer of a conductive metal. Here, the EIL preferably includes a low work function metal or metal salt, and if so, the thicker capping layer does not need to have a low work function. One such cathode is comprised of a thin layer of LiF followed by a thicker layer of Al as described in U.S. Pat. No. 5,677,572. Other useful cathode material sets include, but are not limited to, those disclosed in U.S. Pat. Nos. 5,059,861; 5,059,862, and 6,140,763.

When light emission is viewed through the cathode, the cathode must be transparent or nearly transparent. For such applications, metals must be thin or one must use transparent conductive oxides, or a combination of these materials. Optically transparent cathodes have been described in more detail in U.S. Pat. No. 4,885,211, U.S. Pat. No. 5,247,190, JP 3,234,963, U.S. Pat. No. 5,703,436, U.S. Pat. No. 5,608,287, U.S. Pat. No. 5,837,391, U.S. Pat. No. 5,677,572, U.S. Pat. No. 5,776,622, U.S. Pat. No. 5,776,623, U.S. Pat. No. 5,714,838, U.S. Pat. No. 5,969,474, U.S. Pat. No. 5,739,545, U.S. Pat. No. 5,981,306, U.S. Pat. No. 6,137,223, U.S. Pat. No. 6,140,763, U.S. Pat. No. 6,172,459, EP 1 076 368, U.S. Pat. No. 6,278,236, and U.S. Pat. No. 6,284,3936. Cathode materials are typically deposited by evaporation, sputtering, or chemical vapor deposition. When needed, patterning can be achieved through many well known methods including, but not limited to, through-mask deposition, integral shadow masking as described in U.S. Pat. No. 5,276,380 and EP 0 732 868, laser ablation, and selective chemical vapor deposition.

Other Useful Organic Layers and Device Architecture

In some instances, layers 109 and 111 can optionally be collapsed into a single layer that serves the function of supporting both light emission and electron transportation. It also known in the art that emitting dopants may be added to the hole-transporting layer, which may serve as a host. Multiple dopants may be added to one or more layers in order to create a white-emitting OLED, for example, by combining blue- and yellow-emitting materials, cyan- and red-emitting materials, or red-, green-, and blue-emitting materials. White-emitting devices are described, for example, in EP 1 187 235, US 20020025419, EP 1 182 244, U.S. Pat. No. 5,683,823, U.S. Pat. No. 5,503,910, U.S. Pat. No. 5,405,709, and U.S. Pat. No. 5,283,182.

Additional layers such as electron or hole-blocking layers as taught in the art may be employed in devices of this invention. Hole-blocking layers are commonly used to improve efficiency of phosphorescent emitter devices, for example, as in US 20020015859.

This invention may be used in so-called stacked device architecture, for example, as taught in U.S. Pat. No. 5,703,436 and U.S. Pat. No. 6,337,492.

Deposition of Organic Layers

The organic materials mentioned above are suitably deposited through sublimation, but can be deposited from a solvent with an optional binder to improve film formation. If the material is a polymer, solvent deposition is usually preferred. The material to be deposited by sublimation can be vaporized from a sublimator “boat” often comprised of a tantalum material, e.g., as described in U.S. Pat. No. 6,237,529, or can be first coated onto a donor sheet and then sublimed in closer proximity to the substrate. Layers with a mixture of materials can utilize separate sublimator boats or the materials can be pre-mixed and coated from a single boat or donor sheet. Patterned deposition can be achieved using shadow masks, integral shadow masks (U.S. Pat. No. 5,294,870), spatially-defined thermal dye transfer from a donor sheet (U.S. Pat. No. 5,688,551, U.S. Pat. No. 5,851,709 and U.S. Pat. No. 6,066,357) and inkjet method (U.S. Pat. No. 6,066,357).

Encapsulation

Most OLED devices are sensitive to moisture or oxygen, or both, so they are commonly sealed in an inert atmosphere such as nitrogen or argon, along with a desiccant such as alumina, bauxite, calcium sulfate, clays, silica gel, zeolites, alkaline metal oxides, alkaline earth metal oxides, sulfates, or metal halides and perchlorates. Methods for encapsulation and desiccation include, but are not limited to, those described in U.S. Pat. No. 6,226,890. In addition, barrier layers such as SiOx, Teflon, and alternating inorganic/polymeric layers are known in the art for encapsulation.

Optical Optimization

OLED devices of this invention can employ various well-known optical effects in order to enhance its properties if desired. This includes optimizing layer thicknesses to yield maximum light transmission, providing dielectric mirror structures, replacing reflective electrodes with light-absorbing electrodes, providing anti glare or anti-reflection coatings over the display, providing a polarizing medium over the display, or providing colored, neutral density, or color conversion filters over the display. Filters, polarizers, and anti-glare or anti-reflection coatings may be specifically provided over the cover or as part of the cover.

### EXAMPLES

The invention and its advantages are further illustrated by the specific examples that follow.

### Examples 1, 5, 9, 13, 18, 23

### Comparative EL Devices

Comparative EL devices not satisfying the requirements of the invention were constructed in the following manner:

A glass substrate coated with a 42 nm layer of indium-tin oxide (ITO) as the anode was sequentially ultrasonicated in a commercial detergent, rinsed in deionized water, degreased in toluene vapor and exposed to oxygen plasma for about 1 min.
a) Over the ITO was deposited a 1 nm fluorocarbon hole-injecting layer (CFx) by plasma-assisted deposition of CHF₃.
b) A hole-transporting layer of N,N′-di-1-naphthalenyl-N,N′-diphenyl-4,4′-diaminobiphenyl (NPB) having a thickness of 75 nm was then evaporated from a tantalum boat.
c) A 37.5 nm light-emitting layer of Alq doped with a first dopant from the “Inv-a” category, in an amount ranging from 0.25% to 2% was then deposited onto the hole-transporting layer. These materials were co-evaporated from tantalum boats. Herein, the doping percentage is reported based on volume/volume ratio. The specific dopants and amounts are indicated in Tables 1-6.
d) A 30 nm electron-transporting layer of tris(8-quinolinolato)aluminum (III) (Alq) was then deposited onto the light-emitting layer. This material was also evaporated from a tantalum boat.
e) On top of the Alq layer was deposited a 220 nm cathode formed of a 10:1 volume ratio of Mg and Ag.

The above sequence completed the deposition of the EL device. The device was then hermetically packaged in a dry glove box for protection against ambient environment.

### Examples 2-4, 6-8, 10-12, 14-17, 19-22, 24-27

### Inventive EL Devices

EL inventive devices were fabricated in the same manner as described above except that, the Alq emitting layer is doped with a combination of two dopants (the emitting “Inv-a” first dopant and the stabilizing “Inv-b” second dopant), one from each category Inv-a and Inv-b. The exact dopant percentages used are reported in Tables 1-6.

The cells thus formed in Examples 1-27 were tested for efficiency in the form of luminance yield (cd/A) measured at 20 mA/cm². CIE color x and y coordinates were determined. It is desirable to have a luminance yield of at least about 7 cd/A and preferably greater than about 8 cd/A. An acceptable green for a high quality full color display device has CIEx of no more than about 0.35 and CIEy no less than about 0.62. The luminance loss was measured by subjecting the cells to a constant current density of 20 mA/cm² at 25° C./70° C., for various amounts of time that are specified for each individual cell/example. The experiments were designed such that a selected first dopant was kept at a constant concentration, while a stabilizer second dopant was added at various concentrations and the effect of the addition recorded. The concentration of the first emitting dopant from the Inv-a category is the oncentration at which the dopant peaks in its performance. Stability for use in a display device is desirably less than about 40% loss after about 300 hours under these accelerated aging conditions. The results of this testing are shown in Tables 1-6.

TABLE 1
Stabilizing effect of stabilizer Inv-1b on DPQA (N,N-
diphenylquinacridone) Green Emitter

| | | % | | | | | |
|---|---|---|---|---|---|---|---|
| | % | Second | | | | | Luminance |
| | First | stabilizer | | | | Luminance | Loss (600 h |
| | dopant | dopant Inv- | | | | Loss (307 h % | % loss |
| Type | Inv-1a | 1b | cd/A | CIEx | CIEy | loss RT) | 70 C.) |
| Example 1 | 0.6 | 0 | 9.67 | 0.306 | 0.654 | 11% | 42% |
| Comp | | | | | | | |
| Example 2 | 0.6 | 0.3 | 9.19 | 0.304 | 0.653 | 4% | 30% |
| Inventive | | | | | | | |
| Example 3 | 0.6 | 0.5 | 9.04 | 0.310 | 0.651 | 3% | 25% |
| Inventive | | | | | | | |
| Example 4 | 0.6 | 1 | 7.04 | 0.309 | 0.649 | 3% | 23% |
| Inventive | | | | | | | |

The data from Examples 1-4 show the effect of the stabilizer dopant Inv-1b on DPQA. Comparative Example 1 shows the electroluminescent and stability properties of DPQA alone. When DPQA and t-butylphenyl naphthacene are co-doped in the emissive layer, the device properties reflect both the high luminance, and the stability enhancement of the stabilizer. It is especially useful in this case to use low concentrations of the stabilizer dopant, to retain the maximum luminance characteristic to one dopant, while gaining the stability benefit inherent to the stabilizer dopant.

TABLE 2
Stabilizing effect of Inv-1b on Green Dopant Inv-6a

| | % | % stabilizer | | | | | Luminance |
|---|---|---|---|---|---|---|---|
| | first | second | | | | Luminance | Loss (235 h |
| | dopant | dopant | | | | Loss (340 h | % loss |
| Type | Inv-6a | Inv-1b | cd/A | CIEx | CIEy | % loss RT) | 70 C.) |
| Example 5 | 0.5 | 0 | 7.26 | 0.310 | 0.636 | 19% | 38% |
| Comparative | | | | | | | |
| Example 6 | 0.5 | 0.25 | 7.76 | 0.311 | 0.636 | 17% | 38% |
| Inventive | | | | | | | |
| Example 7 | 0.5 | 0.5 | 7.83 | 0.310 | 0.639 | 12% | 31% |
| Inventive | | | | | | | |
| Example 8 | 0.5 | 1 | 6.67 | 0.316 | 0.636 | 11% | 23% |
| Inventive | | | | | | | |

The data from Examples 5-8 show the effect of the stabilizer dopant Inv-1b on another green dopant, Inv-6a. The data in this set illustrates the superior stability of the fluorinated dimethylquinacridone when co-doped with Inv-1b. Especially useful combination is 0.5% of Inv-6a together with 1% of Inv-1b in the emissive layer, as shown by Example 8. That particular formulation provided the best combination of high stability without a significant drop in luminanance. It is also interesting to note that the emission color resulting from the combination of host and dopant 1 is not significantly affected by the addition of the second (stabilizer) dopant.

TABLE 3
Stabilizing effect of Inv-1b on the Coumarin Inv-8a

| | % | % stabilizer | | | | | Luminance |
|---|---|---|---|---|---|---|---|
| | first | second | | | | Luminance | Loss (240 h |
| | dopant | dopant | | | | Loss (340 h | % loss |
| Type | Inv-8a | Inv-1b | cd/A | CIEx | CIEy | % loss RT) | 70 C.) |
| Example 9 | 0.5 | 0 | 9.45 | 0.284 | 0.646 | 22% | 43% |
| Comparative | | | | | | | |
| Example 10 | 0.5 | 0.25 | 11.6 | 0.289 | 0.649 | 22% | 45% |
| Inventive | | | | | | | |
| Example 11 | 0.5 | 0.5 | 9.63 | 0.292 | 0.646 | 16% | 37% |
| Inventive | | | | | | | |
| Example 12 | 0.5 | 1 | 8.22 | 0.298 | 0.643 | 13% | 30% |
| Inventive | | | | | | | |

The same stabilizing effect of Inv-1b was observed with the coumarin Inv-8a which a very high efficiency but a very poor stability by itself. Example 12 provides a useful formulation of the two dopants, such that luminance only suffers about a 10% loss, while stability is greatly improved (compare 22% loss of luminance when Inv-8a is doped by itself, to 13% loss when co-doped with 1% Inv-1b at 25° C.).

TABLE 4
Stabilizing effect of Inv-3b on DPQA

| | % | % stabilizer | | | | | Luminance |
|---|---|---|---|---|---|---|---|
| | first | second | | | | Luminance | Loss (240 h |
| | dopant | dopant | | | | Loss (310 h | % loss |
| Type | Inv-1a | Inv-3b | cd/A | CIEx | CIEy | % loss RT) | 70 C.) |
| Example 13 | 0.6 | 0 | 8.23 | 0.310 | 0.647 | 7% | 30% |
| Comparative | | | | | | | |
| Example 14 | 0.6 | 0.3 | 8.46 | 0.311 | 0.648 | 3% | 23% |
| Inventive | | | | | | | |
| Example 15 | 0.6 | 0.5 | 7.20 | 0.313 | 0.641 | 5% | 18% |
| Inventive | | | | | | | |
| Example 16 | 0.6 | 0.8 | 6.25 | 0.317 | 0.641 | 5% | 13% |
| Inventive | | | | | | | |
| Example 17 | 0.6 | 1 | 5.75 | 0.319 | 0.640 | 10% | 12% |
| Inventive | | | | | | | |

The data illustrated by Examples 13-17 show the effect of the stabilizer dopant Inv-3b on DPQA. The same trend is observed as with the stabilizer Inv-1b: as stabilizer is added to the emissive layer containing DPQA, the lifetime of the device increases (as illustrated by the numbers in the last column), however the efficiency of the device decreases. An especially useful combination is 0.6% of DPQA (Inv-1a) together with 0.5-0.8% Inv-3b in the emissive layer, as shown by Examples 15 and 16.

TABLE 5
Stabilizing effect of Inv-3b on Inv-6a (fluorinated
dimethylquinacridone)

| | % | % stabilizer | | | | | Luminance |
|---|---|---|---|---|---|---|---|
| | first | second | | | | Luminance | Loss (215 h |
| | dopant | dopant | | | | Loss (320 h | % loss |
| Type | Inv-6a | Inv-3b | cd/A | CIEx | CIEy | % loss RT) | 70 C.) |
| Example 18 | 0.5 | 0 | 5.71 | 0.314 | 0.635 | 18% | 34% |
| Comparative | | | | | | | |
| Example 19 | 0.5 | 0.3 | 6.28 | 0.314 | 0.637 | 14% | 27% |
| Inventive | | | | | | | |
| Example 20 | 0.5 | 0.5 | 5.14 | 0.318 | 0.634 | 10% | 20% |
| Inventive | | | | | | | |
| Example 21 | 0.5 | 1 | 4.38 | 0.323 | 0.631 | 7% | 15% |
| Inventive | | | | | | | |
| Example 22 | 0.5 | 2 | 3.8 | 0.330 | 0.627 | 5% | 7% |
| Inventive | | | | | | | |

This stabilizer, dipyrenenaphthacene (DpyN), shows the same stabilizing effect on Inv-6a as the analogous stabilizer di-tbutylphenylnaphthacene. Especially useful for practical applications are concentrations of the stabilizer where the loss in efficiency is relatively small and the gain in stability is high. Examples 20 and 21 show that, with this particular dopant, the stabilizer gives best results at concentrations between 0.5% and 1%.

TABLE 6
Stabilizing effect of Inv-3b on Coumarin Inv-8a

| | % | % stabilizer | | | | | Luminance |
|---|---|---|---|---|---|---|---|
| | first | second | | | | Luminance | Loss (240 h |
| | dopant | dopant | | | | Loss (340 h | % loss |
| Type | Inv-8a | Inv-3b | cd/A | CIEx | CIEy | % loss RT) | 70 C.) |
| Example 23 | 0.5 | 0 | 9.36 | 0.289 | 0.646 | 23% | 45% |
| Comparative | | | | | | | |
| Example 24 | 0.5 | 0.3 | 8.92 | 0.296 | 0.644 | 12% | 35% |
| Inventive | | | | | | | |
| Example 25 | 0.5 | 0.5 | 7.71 | 0.299 | 0.646 | 8% | 30% |
| Inventive | | | | | | | |
| Example 26 | 0.5 | 0.8 | 6.72 | 0.309 | 0.640 | 8% | 22% |
| Inventive | | | | | | | |
| Example 27 | 0.5 | 1 | 5.71 | 0.316 | 0.637 | 8% | 20% |
| Inventive | | | | | | | |

The effect of the stabilizer DPyN on the coumarin dopant is reflected in Table 6. As seen with other dopants, it is beneficial to keep the stabilizer concentration low (0.5-0.8%) as shown by Examples 25 and 26.

The data from examples 1-27 shows the stabilizing effect of naphthacene green emitting dopants, when co-doped in the green layer with quinacridone or coumarin dopants. The stability effect is especially useful when the doping levels of the stabilizer are below 1%, such that the loss of luminance, usually encountered when stabilizers are introduced in the emissive layer, is small (10-15%) and the stability improvement doubles or triples. In addition, the data shows that the color of the emitting dopant (CIEx,y coordinates) is not significantly affected at low levels of the stabilizer dopant (0.25-1% of the host), which is another advantage.

The entire contents of the patents and other publications referred to in this specification are incorporated herein by reference. The invention has been described in detail with particular reference to certain preferred embodiments thereof, but it will be understood that variations and modifications can be effected within the spirit and scope of the invention.

### Parts List

101 Substrate
103 Anode
105 Hole-Injecting Layer (HIL)
107 Hole-Transporting Layer (HTL)
109 Light-Emitting Layer (LEL)
111 Electron-Transporting Layer (ETL)
113 Cathode

1. An electroluminescent device having a cathode and an anode, an organic light emitting layer (LEL) containing at least one organic host material and a light emitting first dopant, and a layer containing a stabilizing second dopant wherein:
a) the organic host material is capable of sustaining both hole and electron injection and recombination of electrons and holes; and
b) the first dopant is a green light emitting organic material capable of accepting energy from the electron-hole recombination in the host material and of accepting energy transferred from the second dopant and is selected to have a bandgap energy lower than or equal to the bandgap energy of the second dopant material;
c) the second dopant is a stabilizing material capable of accepting energy of electron-hole recombination in the host material, the second dopant being selected to have a bandgap energy lower than the bandgap energy of the host material, but higher or equal to the first dopant;
wherein emissions from the first dopant and emissions from the second dopant, if any, have a peak emission in the OLED device less than 570 nm.

2. The device of claim 1 wherein the second dopant is located in the Light Emitting Layer LEL.

3. The device of claim 1 wherein both the stabilizing second dopant and the first dopant emit green light with peak emission in the OLED device in the range of 490-540 nm.

4. The device of claim 1 wherein the dopants are each independently present in an amount of up to 10 wt % of the host.

5. The device of claim 1 wherein the first dopant is present in an amount of less than 3 wt % of the host, and the second dopant is present in an amount less than 5 wt % of the host.

6. The device of claim 1 wherein both the first dopant and the second dopant are present independently in amounts of 0.5-1.0% of the host

7. The device of claim 1 comprising in the LEL a first host material, a second host material or a mixture of a first host and a second host material.

8. The device of claim 7 wherein the first host comprises a chelated oxinoid compound.

9. The device of claim 8 wherein the chelated oxinoid compound comprises a member selected from the group consisting of:
Aluminum trisoxine [alias, tris(8-quinolinolato)aluminum(III)];
Magnesium bisoxine [alias, bis(8-quinolinolato)magnesium(II)];
Bis[benzo {f}-8-quinolinolato]zinc (II);
Bis(2-methyl-8-quinolinolato)aluminum(III)-μ-oxo-bis(2-methyl-8-quinolinolato) aluminum(III);
Indium trisoxine [alias, tris(8-quinolinolato)indium];
Aluminum tris(5-methyloxine) [alias, tris(5-methyl-8-quinolinolato) aluminum(III)];
Lithium oxine [alias, (8-quinolinolato)lithium(I)];
Gallium oxine [alias, tris(8-quinolinolato)gallium(III)]; and
Zirconium oxine [alias, tetra(8-quinolinolato)zirconium(IV)].

10. The device of claim 8 wherein the first host comprises Aluminum trisoxine [alias, tris(8-quinolinolato)aluminum(III)].

11. The device of claim 8 wherein the second host comprises an anthracene compound comprising derivatives of 9,10-di-(2-naphthyl)anthracene (Formula F) 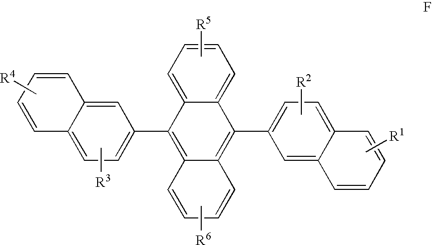
wherein: R₁, R², R³, R⁴, R⁵, and R⁶ represent one or more substituents on each ring where each substituent is individually selected from the following groups:
Group 1: hydrogen, or alkyl of from 1 to 24 carbon atoms;
Group 2: aryl or substituted aryl of from 5 to 20 carbon atoms;
Group 3: carbon atoms from 4 to 24 necessary to complete a fused aromatic ring of anthracenyl; pyrenyl, or perylenyl;
Group 4: heteroaryl or substituted heteroaryl of from 5 to 24 carbon atoms as necessary to complete a fused heteroaromatic ring of furyl, thienyl, pyridyl, quinolinyl or other heterocyclic systems;
Group 5: alkoxylamino, alkylamino, or arylamino of from 1 to 24 carbon atoms; and
Group 6: fluorine, chlorine, bromine or cyano.

12. The device of claim 1 where the first dopant comprises a material of the Formula 1, 2 or 3: 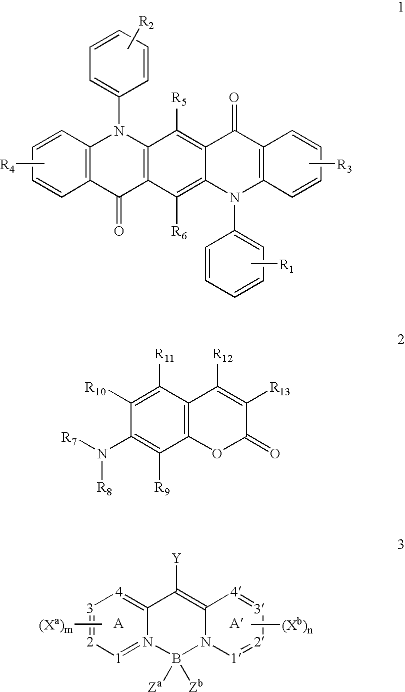
wherein in Formula 1, R₁-R₆ represent hydrogen, one or more substituents such as halogen, alkyl, cyano group, nitro group, hydroxy, alkoxy group, aryloxy group, aryl group, an alkylthio group, arylthio group or an aromatic heterocycle. R₁ or R₂ may form a fused aromatic or heteroaromatic ring to the phenyl moiety. R₃ and R₄ do not form fused aromatic rings to the central quinacridone structure.
In Formula 2, R₉-R₁₃ independently represents hydrogen, halogen, alkyl, alkoxy, alkylthio group, arylthio group, aryl, an electron withdrawing group such as a cyano group, nitro group or trifluoromethyl group, an aromatic heterocycle, or an heterocyclic ring fused to the aromatic moiety. R₇ and R₈ independently represent an alkyl group, aryl group, an aromatic heterocycle or a heterocyclic group fused together, and/or fused to the aromatic moiety. All of the ring substituents may be themselves further substituted, using substituents selected by those skilled in the art to attain a desired property.
In Formula 3, each X^{a} and X^{b} is an independently selected substituent, two of which may join to form a fused ring to the azine ring moiety; m and n are independently 0 to 4; Y is H or a substituent; Z^{a} and Z^{b} are independently selected substituents; 1, 2, 3, 4, 1′, 2′, 3′, and 4′ are independently selected as either carbon or nitrogen atoms. The device may desirably contain at least one or both of rings A and A′, that contains substituents joined to form a fused ring. In one useful embodiment, there is present at least one X^{a} or X^{b} group selected from the group consisting of halide and alkyl, aryl, alkoxy, and aryloxy groups. In another embodiment, there is present a Z^{a} and Z^{b} group are independently selected from the group consisting of fluorine and alkyl, aryl, alkoxy and aryloxy groups. Y is suitably hydrogen or a substituent such as an alkyl, aryl, halogen, cyano group or a heterocyclic group.

13. The device of claim 12 wherein the first dopant is one of formula 1.

14. The device of claim 12 wherein the first dopant is one of formula 2.

15. The device of claim 12 wherein the first dopant is one of formula 3.

16. The device of claim 12 wherein the first dopant comprises: Inv-1a, Inv-6a or Inv-8a.

17. The device of claim 1 where the second dopant comprises a material of Formula 4′: 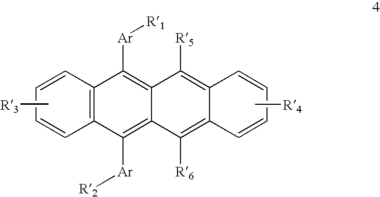
wherein each Ar is an aromatic carbocyclic or heterocyclic ring, R′₁-R′₆ independently represent hydrogen or one or more substituents selected from halogen, cyano group, nitro group, an alkyl group, hydroxy, alkoxy group, aryloxy group, an alkylthio group, an amino group, an arylthio group, either an aryl group or an aromatic heterocycle, either of which can be fused to the phenyl moiety provided R₁₃ and R₁₄ do not form fused rings to the central naphthacene structure.

18. The device of claim 17 where the second dopant comprises a material of Formula 4″

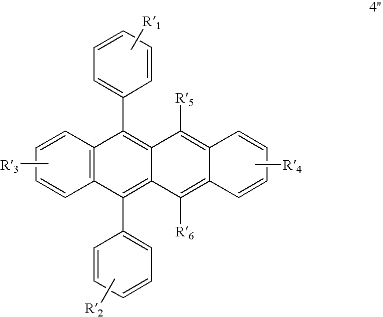

19. The device of claim 17 wherein the second dopant is a 5,12-disubstituted tetracene or a derivative thereof.

20. The device of claim 17 wherein the second dopant is a 5,12-diaryltetracene

21. The device of claim 17 wherein the second dopant is selected from the group consisting of

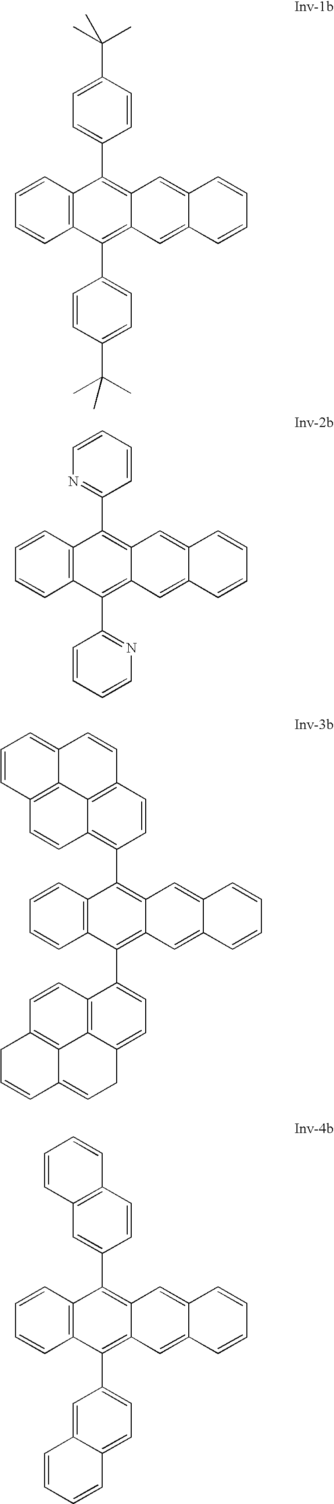

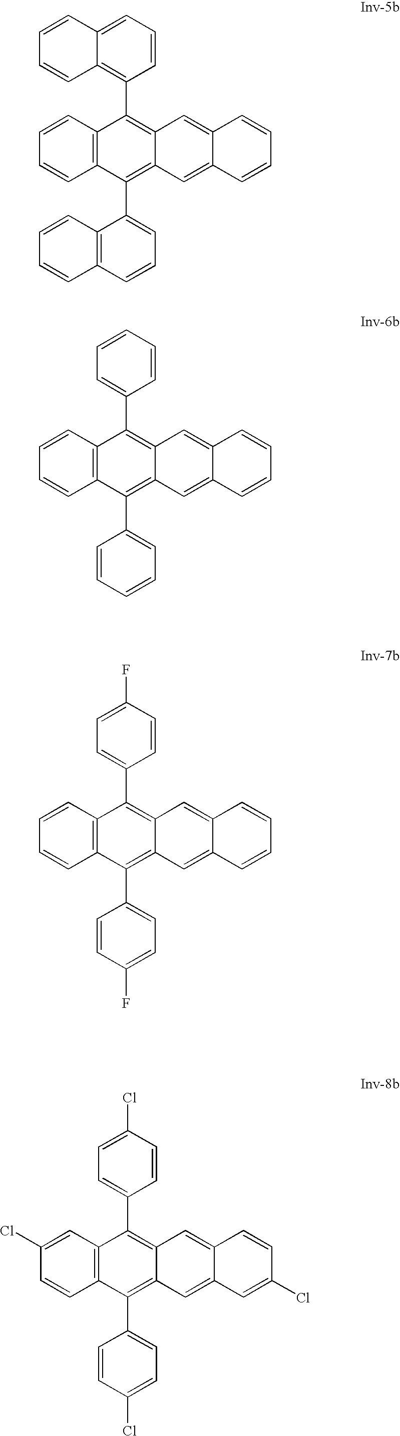

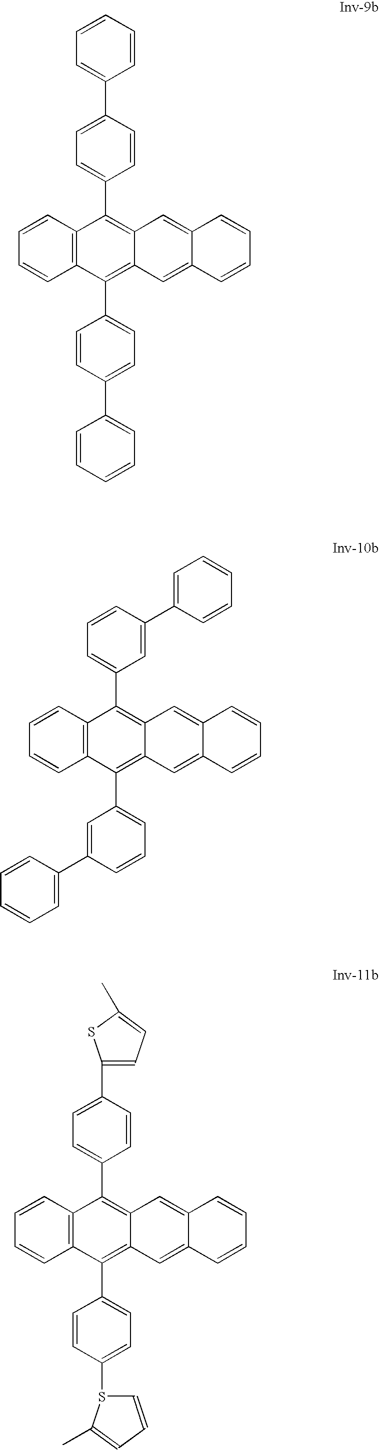

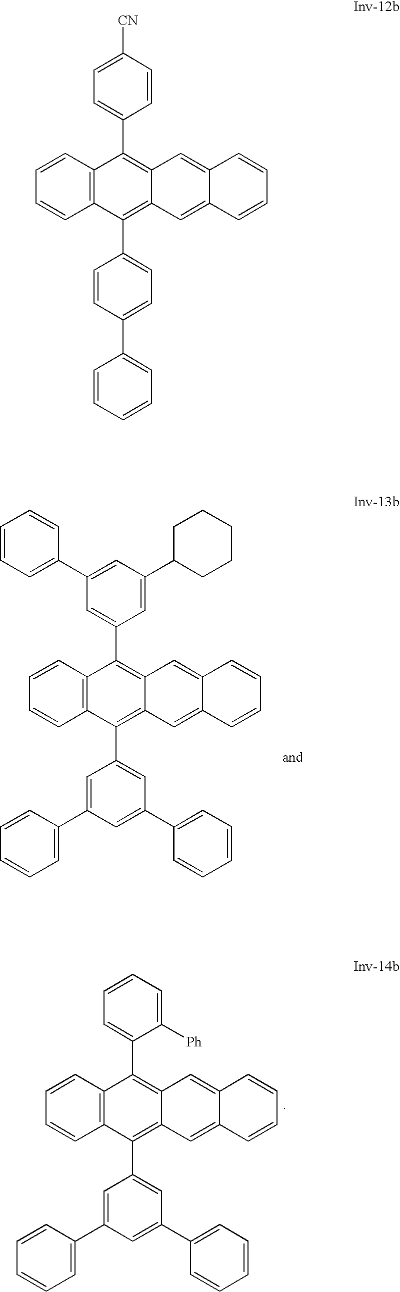

22. The device of claim 21 wherein the second dopant is Inv-1b or Inv-3b.
